(19) United States
(12) Patent Application Publication
(10) Pub. No.: US 2014/0149925 A1
(43) Pub. Date: May 29, 2014

(54) DISPLAYING SYSTEM WITH NAVIGATION FUNCTION AND DISPLAYING METHOD THEREOF

(71) Applicants: INVENTEC (PUDONG) TECHNOLOGY CORPORATION, Shanghai (CN); INVENTEC CORPORATION, Taipei City (TW)

(72) Inventor: Long Chen, Shanghai (CN)

(73) Assignees: INVENTEC CORPORATION, Taipei City (TW); INVENTEC (PUDONG) TECHNOLOGY CORPORATION, Shanghai (CN)

(21) Appl. No.: 13/783,117

(22) Filed: Mar. 1, 2013

(30) Foreign Application Priority Data
Nov. 29, 2012 (CN) 201210501505.7

(51) Int. Cl. G06F 3/0485

(52) U.S. Cl. CPC G06F 3/0485
USPC 715/786

(57) ABSTRACT

A displaying system with a navigation function and displaying method thereof produce a navigation element with at least one link block in a displaying block. Each of the link blocks corresponds to a function element. When a click operation is detected on one link block, the scroll element is triggered for displaying the function element corresponding to the clicked link block in a viewable area of the displaying block. The mechanism helps improve browsing.

### BACKGROUND OF THE INVENTION

1. Field of Invention

The invention relates to a displaying system with a navigation function and the displaying method thereof. In particular, the invention relates to a displaying system with a navigation function that displays a function element corresponding to a clicked link block in a viewable area of a displaying block and the displaying method thereof.

2. Related

In recent years, with the popularity of computers, people have become accustomed to using a computer to handle daily affairs. However, the range of the computer screen display is limited. When using multiple function elements (sub-windows) at the same time, there is a problem that not all function elements can be shown in the viewable area.

In general, when the number of function elements exceeds that which can be accommodated by the viewable area, a scroll element, e.g., a scroll bar in the displaying block, is provided to enable the user to use this scroll element to adjust the function elements in the viewable area. However, when the number of function elements is huge, one may need to continuously operate the scroll bar to adjust the desired function elements into the viewable area. It is thus inconvenient for browsing.

In view of this, some vendors propose a paging display method. The function elements are displayed on different pages. In this way, users can quickly switch among different pages for different function elements and the browsing messages provided by the function elements. However, the paging method can only display the message of one function element at a time, instead of the messages of multiple function elements simultaneously in the viewable area. Therefore, the user has to switch among different pages in order to simultaneously browse multiple function elements. Consequently, the above-mentioned method still cannot effectively solve the problem in browsing.

In summary, the prior art always has the problem of inconvenience in browsing. It is therefore necessary to provide an improved technical means to solve this problem.

### SUMMARY OF THE INVENTION

In view of the foregoing, the invention provides a displaying system with a navigation function and displaying method thereof.

The disclosed displaying system with a navigation function includes: an initialization module, a displaying module, a detection module, and a navigation module. The initialization module initializes a navigation element, which contains multiple link blocks each of which has a corresponding function element. After the navigation element initializes, the displaying module generates a displaying block containing a scroll element and link blocks of the navigation elements and the corresponding function elements. The detection module continuously detects any click operation. When the click operation occurs on one of the link blocks, a trigger signal is generated. The navigation module drives the scroll element according to the trigger signal to show the function element corresponding to the clicked link block in the viewable area of the display block.

The disclosed displaying method with a navigation function comprises the steps of: initializing a navigation element, which includes a plurality of link blocks, each of which corresponds to a function element; generating a display block having a scroll element, and displaying the link blocks of the navigation element and the corresponding function elements simultaneously in the display block; continuously detecting any click operation and generating a trigger signal when one of the link blocks has a click operation; driving the scroll element according to the trigger signal to display the function element corresponding to the clocked link block in the viewable area of the display block.

The disclosed system and method differ from the prior art in that the present invention generates a navigation element having link blocks in the display block. Each link block corresponds to a function element. When a click operation is detected on one link block, a scroll element is triggered so that the function element corresponding to the clicked link block is displayed in the viewable area of the display block.

Through the above-mentioned technical means, the present invention achieves the goal of improving the convenience in web browsing.

### DESCRIPTION OF THE DRAWINGS

The invention will become more fully understood from the detailed description given herein below illustration only, and thus is not limitative of the present invention, and wherein:

FIG. 1 is a system block diagram of the disclosed displaying system with a navigation function;

FIG. 2 is a flowchart of the disclosed displaying method with a navigation function;

FIG. 3 is a schematic view of the display block according to the invention;

FIG. 4 is a schematic view showing that the disclosed scroll element adjusts the function element to the viewable area;

FIG. 5 is a schematic view of clicking a link block to display the corresponding function element;

FIG. 6 is a schematic view of hiding the scroll element according to the invention; and

FIG. 7 is a schematic view of embedding the function message of the function element into the corresponding link block for display.

### DETAILED DESCRIPTION OF THE INVENTION

The present invention will be apparent from the following detailed description, which proceeds with reference to the accompanying drawings, wherein the same references relate to the same elements.

Before describing the disclosed system and method with a navigation function, we first define terms used herein. The navigation element is an element at the top or bottom of a display block. In practice, the navigation element contains multiple link blocks. Every link block corresponds to a function element. When the user clicks a link block using the cursor or by touching, the function element corresponding to the clicked link block is moved to the viewable area of the display block to be displayed.

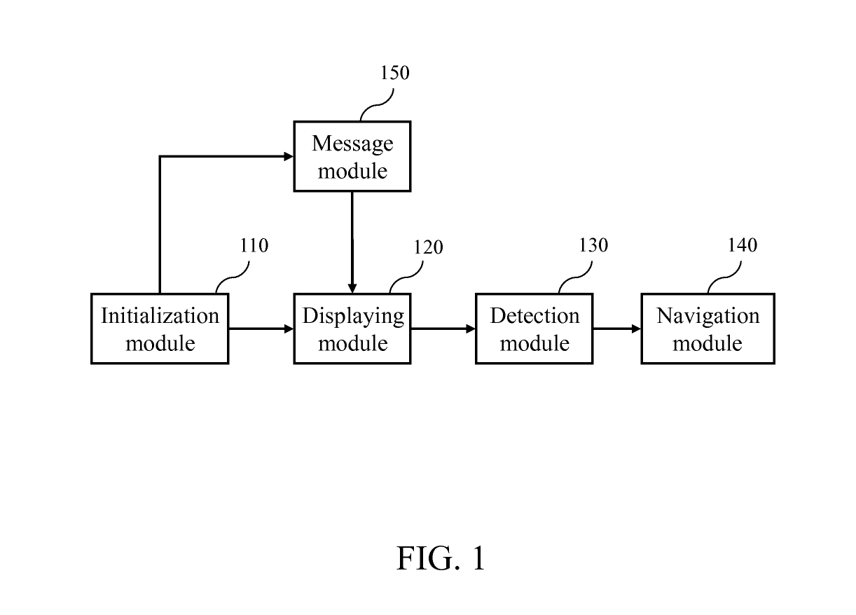

Please refer to FIG. 1. FIG. 1 is a system block diagram of the disclosed display system with a navigation function. The system includes: an initialization module 110, a displaying module 120, a detection module 130, and a navigation module 140. The initialization module 110 initializes a navigation element having a plurality of link blocks, each of which corresponds to one function element. The navigation element has been described above. In practice, the link block is shown graphically.

After the navigation element is initialized, the displaying module 120 generates a display block containing a scroll element. The scroll element is a vertical scroll bar that enables the user to adjust the display position of the function elements using a cursor, a wheel, or by touching. In addition, the displaying module 120 simultaneously displays all link blocks of the navigation element and the corresponding function elements in the display block. In practice, the display positions and the display sizes of the link blocks are adjusted according to the default coordinate and dimension parameters of the corresponding function elements. In addition, when the link blocks of the navigation element and the corresponding function elements are displayed in the viewable area of the display block at the same time, the scroll element can be hidden. The invention can even adjust the display positions of the link blocks and the function elements after the scroll element is hidden.

The detection module 130 continuously detects any click operation by the user. When a click operation is done on one of the link blocks, a trigger signal is generated. For example, when the user moves the cursor to a link block and clicks the left button of the mouse, the detection module 130 detects the user's click operation, and generates a trigger signal corresponding to the clicked link block. In practice, the trigger signal may contain the identification (ID) code of the function element corresponding to the link block. The navigation module 140 can thus displays the corresponding function element in the viewable area in accordance with this ID code.

After the detection module 130 generates a trigger signal, the navigation module 140 drives the scroll element according to the trigger signal, so that the function element corresponding to the clicked link block can be displayed in the viewable area of the display block. For example, suppose that the scroll element has a first link block, a second link block, and a third link block. The three link blocks respectively correspond to a first function element, a second function element and a third function element. Suppose the current viewable area shows only the first function element. When the user clicks the third link block, the navigation module 140 moves the third function element from the non-viewable area to the viewable area. If the first function element and the second function element cannot be displayed in the viewable area at the same time, they are moved by the navigation module 140 to a non-viewable area.

It should be noted that the system may further include a message module 150 for reading function message in the function element and for embedding the function message in the corresponding link block for display. For example, suppose that the function element has the function message, such as “CPU usage: 50%.” In this case, the message module 150 embeds the function message “CPU usage: 50%” in the corresponding link block for display. In this way, the user can even directly browse the link block to get the message provided by the corresponding function element without any click operation. In practice, the function message contains at least image, video, or text, or even an arbitrary combination of the three.

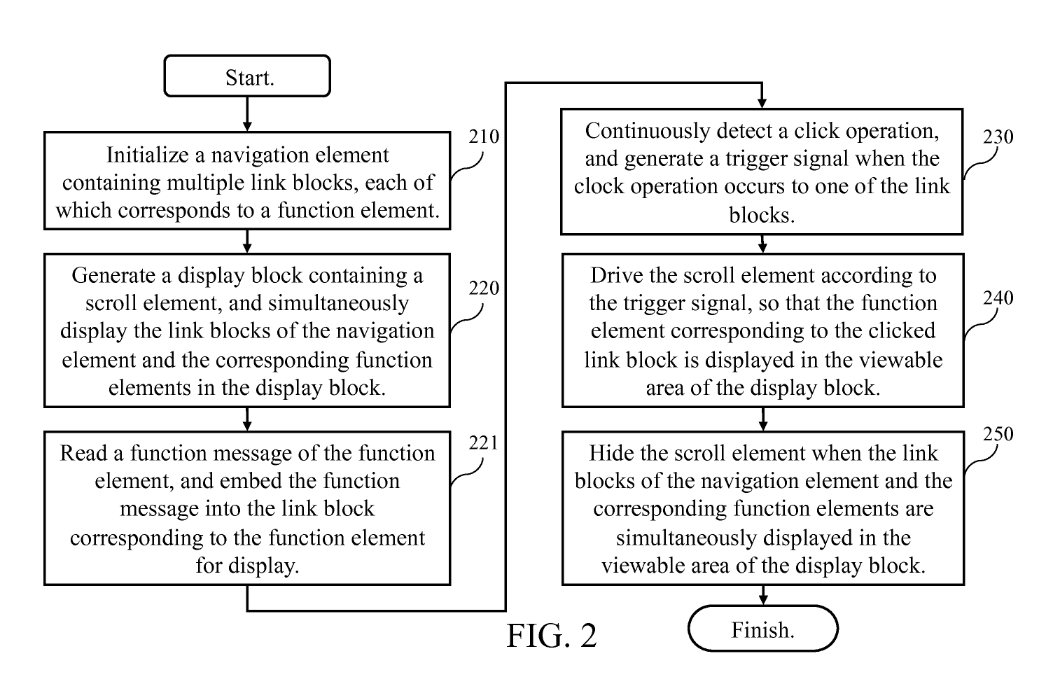

FIG. 2 is a flowchart of the disclosed displaying method with a navigation function. The method comprises the steps of: initializing a navigation element containing multiple link blocks, each of which corresponds to a function element (step 210); after initializing the navigation element, generating a display block that contains a scroll element, and displaying the link blocks of the navigation element and the corresponding function elements at the same time in the display block (step 220); continuously detecting any click operation, and generating a trigger signal when a click operation on one of the link blocks is detected (step 230); after the trigger signal is generated, using the navigation module to drive the scroll element according to the trigger signal to display the function element corresponding to the clicked link block in the viewable area of the display block (step 240). Through the above-mentioned steps, the display block contains the navigation element with the link blocks, each of which has a corresponding function element. When a click operation on one link block is detected, the scroll element is triggered so that the function element corresponding to the clicked link block is shown in the viewable area of the display block.

Furthermore, after step 220, the method reads a function message of the function element, and embeds the function message in the link block corresponding to the function element to be displayed (step 221). When the link blocks of the navigation element and the corresponding function elements are displayed in the viewable area of the display block at the same time, the scroll element is hidden (step 250).

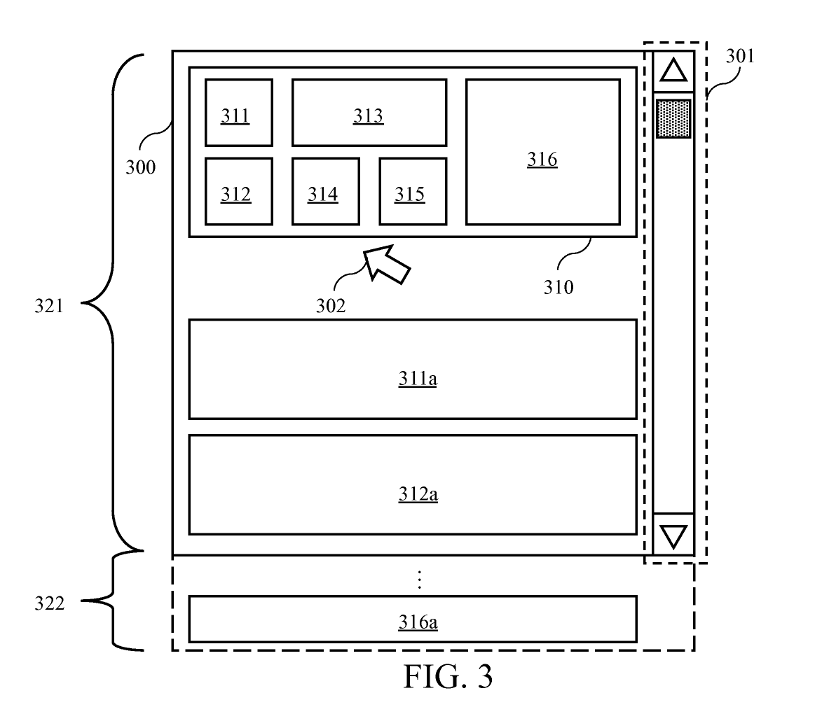

An embodiment is described below with reference to FIG. 3 to FIG. 7. FIG. 3 is a schematic view of the display block. As previously mentioned, after the initialization of the navigation element 310, the displaying module 120 generates the display block 300 containing the scroll elements 301. The navigation element 310, the link blocks (311 to 316) therein, and the function elements corresponding to the link blocks (311 to 316) are shown in the display block 300. As the number of function elements is beyond what the viewable area 321 of the display block 300 can accommodate, the user can see only two function elements (311a, 312a). The other function elements (e.g., function element 316a) are in the non-viewable area 322 (indicated by the long-dashed line) of the display block 300. They can be moved from the non-viewable area 322 to the viewable area 321 once the scroll element 301 is driven. The user can use the cursor 302 to click a link block (311 to 316) in order to display the function element corresponding to the clicked link block in the viewable area 321 in display block 300.

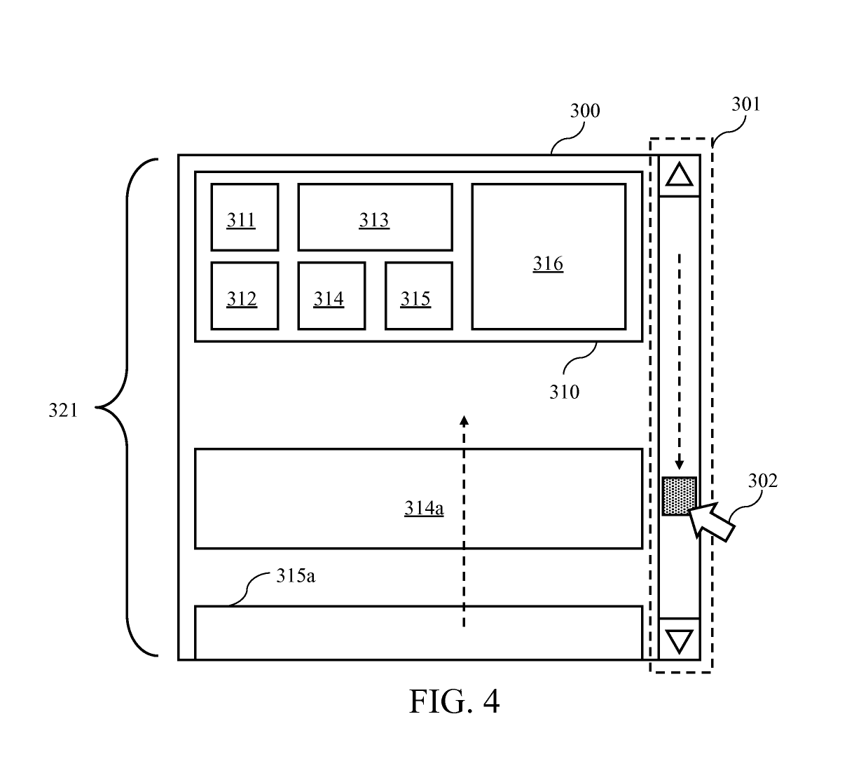

FIG. 4 schematically shows that the invention drives the scroll element to adjust the function element to the viewable area. In an embodiment of the invention, the scroll element 301 can be driven manually by the user or by the navigation module 140 according to the trigger signal. Take the example that the user uses the cursor 302 to drive the scroll element 301. As shown in FIG. 4, the user can drag to drive the scroll element 301. In this case, the viewable area 321 of the display block 300 adjusts the displayed function elements upwards, as indicated by the dashed arrow, e.g., the function elements 314a, 315a. In practice, the link blocks 311˜316 of the navigation element 310 can be displayed at the top. When the function elements 314a, 315a are continuously moved upwards and overlap with the navigation element 310, the function elements 314a, 315a are displayed are displayed at the bottom of the navigation element 310, or even moved out of the viewable area 321. Since such processing belongs to the prior art, it is not further described herein.

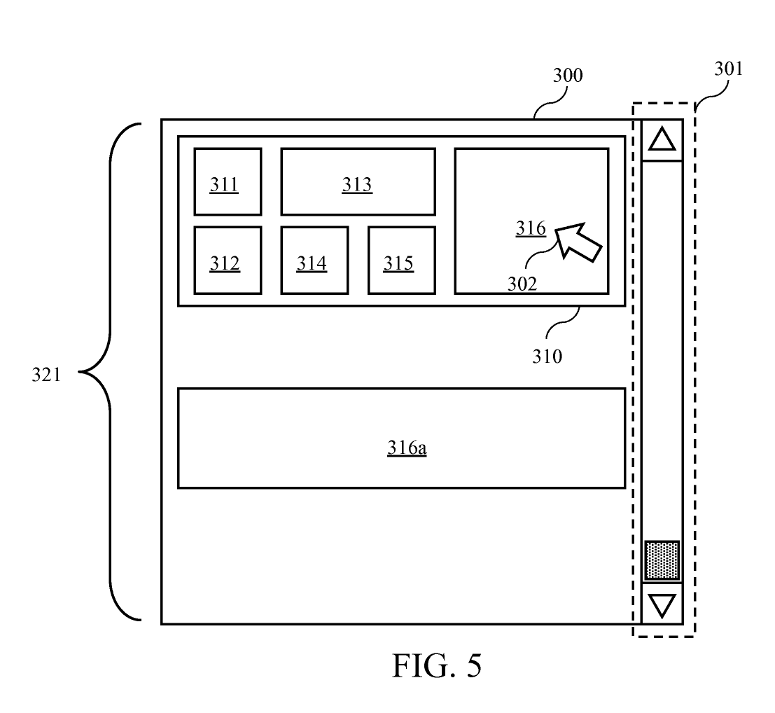

FIG. 5 is a schematic view showing that a link block is clicked to display the corresponding function element. Suppose that the user moves the cursor 302 to the link block 316 and performs a click operation. After the detection module 130 detects this click operation, a trigger signal is correspondingly generated. For example, the trigger signal contains the ID code of the function element 316a corresponding to the link block 316. Afterwards, the navigation module 140 drives the scroll element 301 according to the trigger signal, as shown in FIG. 5 in order to move the function element 316a of the same ID code to the viewable area 321 of the display block 300.

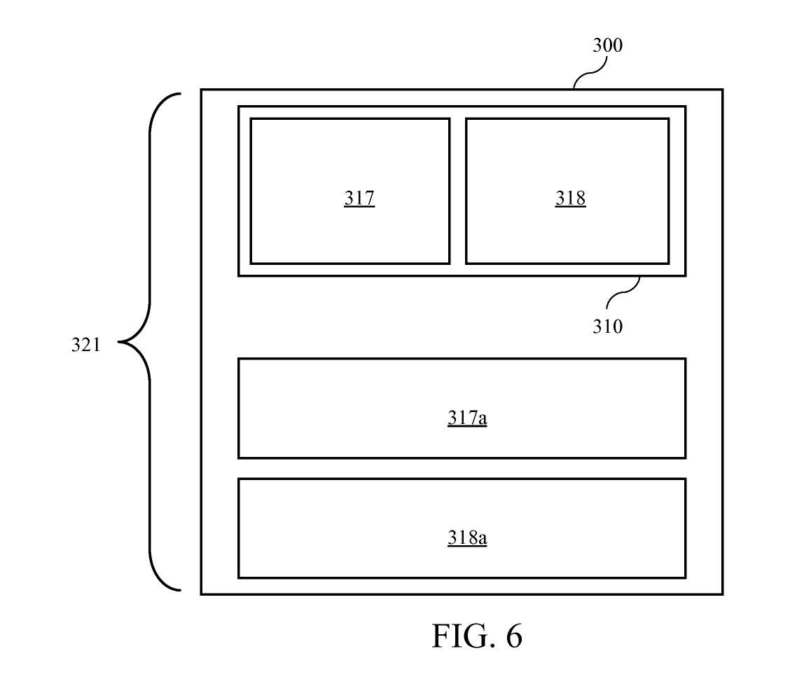

FIG. 6 is a schematic view of hiding the scroll element according to the invention. As mentioned earlier, in practice, when the link blocks 317, 318 of the navigation element 310 and the corresponding function elements 317a, 318a can be simultaneously displayed in the viewable area of the display block 300, 321, the scroll element (as shown in FIG. 5) can be hidden. In this embodiment, there are two link blocks 317, 318. The function elements 317a, 318a corresponding to the two link blocks 317, 318 are simultaneously displayed in the viewable area 321. Therefore, the scroll element is not displayed. Even the display positions of the navigation element 310 and the link blocks 317a, 318a can be adjusted because the scroll element is hidden (e.g., shifting to the right).

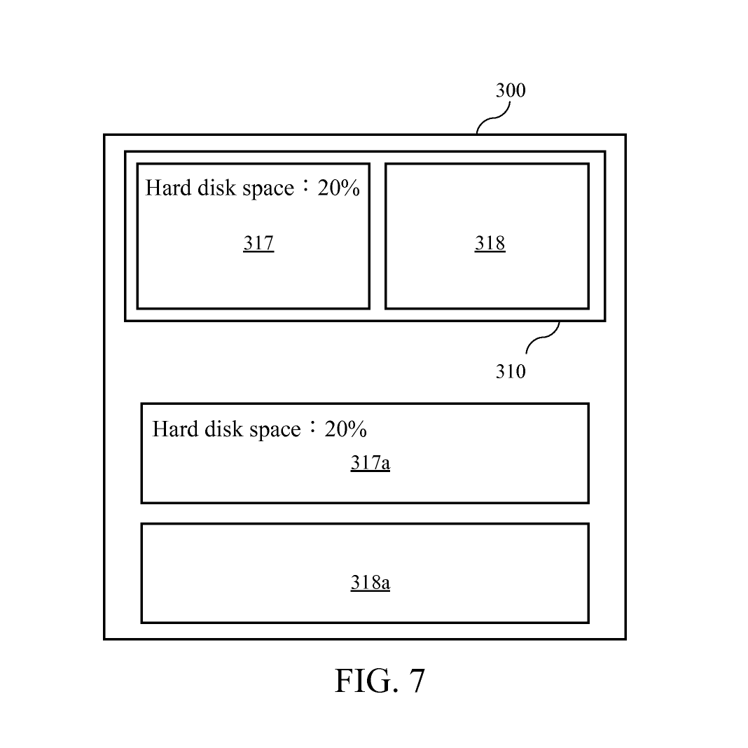

FIG. 7 is a schematic view showing that the invention embeds the function message of the function element to the corresponding link block for display. In practice, the message module 150 reads the function message of the function element, e.g., “Hard disk space: 20%.” Afterwards, the message module 150 embeds the function messages “Hard disk space: 20%” to the corresponding link block 317. As shown in FIG. 7, the link block 317 displays the embedded function message “Hard disk space: 20%.” It should be noted that although the invention illustrates the function message in text, one should not use this to limit the scope of the invention. Any images, videos, or text that can be displayed should be included by the invention.

In summary, the invention differs from the prior art in that the navigation element containing the link blocks is generated in the display block. Each link block corresponds to one function element. When a click operation is detected in one link block, the scroll element is triggered to display the function element corresponding to the clicked link block in the viewable area of the display block. The invention achieves the goal of improving the convenience in browsing.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A displaying system with a navigation function, comprising:
an initialization module for initializing a navigation element having a plurality of link blocks, each of which has a corresponding function element;
a displaying module for generating a display block containing a scroll element after the initialization of the navigation element and simultaneously displaying the link blocks of the navigation element and the corresponding function elements in the display block;
a detection module for continuously detecting any click operation and generating a trigger signal when a click operation occurs to one of the link blocks; and
a navigation module for driving the scroll element according to the trigger signal after the generation of the trigger signal so that the function element corresponding to the clicked block is displayed in a viewable area of the display block.

2. The displaying system of claim 1 further comprising a message module for reading a function message of the function element and embedding the function message into the corresponding link block for display.

3. The displaying system of claim 2, wherein the function message includes at least an image, video, or text.

4. The displaying system of claim 1, wherein the scroll element is hidden when the link blocks of the navigation element and the corresponding function elements are displayed in the viewable area of the display block.

5. The displaying system of claim 1, wherein the link blocks adjust the display positions and display sizes thereof according to a coordinate parameter and a dimension parameter set for the corresponding function element by default.

6. A displaying method with a navigation function, comprising the steps of:
initializing a navigation element having a plurality of link blocks, each of which has a corresponding function element;
generating a display block containing a scroll element after the initialization of the navigation element and displaying simultaneously the link blocks of the navigation element and the corresponding function elements in the display block;
continuously detecting a click operation and generating a trigger signal when a click operation occurs to one of the link blocks; and
driving the scroll element according to the trigger signal so that the function element corresponding to the clicked link block is displayed in the viewable area of the display block.

7. The displaying method of claim 6 further comprising the step of reading a function message of the function element and embedding the function message to the link block corresponding to the function element for display.

8. The displaying method of claim 7, wherein the function message includes at least an image, video, or text.

9. The displaying method of claim 6 further comprising the step of hiding the scroll element when the link blocks of the navigation element and the corresponding function elements are displayed in the viewable area of the display block.

10. The displaying method of claim 6, wherein the link blocks adjust the display positions and display sizes thereof according to a coordinate parameter and a dimension parameter set for the corresponding function element by default.
